(19) United States
(12) Patent Application Publication
(10) Pub. No.: US 2007/0138334 A1
(43) Pub. Date: Jun. 21, 2007

(54) Water-cooling apparatus for wire/rod rolling mill

(75) Inventors: Klaus Kuppers, Erkrath (DE); Uwe Plociennik, Ratingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: SMS Meer GmbH

(21) Appl. No.: 11/640,013

(22) Filed: Dec. 15, 2006

(30) Foreign Application Priority Data
Dec. 17, 2005 (DE) 102005060545.1

(51) Int. Cl. B65H 23/24; G03B 1/52

(52) U.S. Cl. 242/615.11

(57) ABSTRACT

A water box for a wire-rolling mill has a lower support and a lower plate carried on the lower support, extending horizontally below a path of a wire moving in a travel direction, and formed with an upwardly open groove extending parallel to and open toward the path. An upper support carries an upper plate formed with a straight groove. Respective upper and lower guide bars seated in the grooves of the upper and lower plates are formed with respective straight channels open away from the respective plates. A hinge connected between the supports permits movement of the upper plate between a closed position closely juxtaposed with the lower plate and with the channels confronting each other and forming a passage surrounding the path and an open position spaced upward away from the lower plate. In the closed position the wire is transversely enclosed by the channels.

### FIELD OF THE INVENTION

The present invention relates to a water-cooling apparatus for a wire/rod rolling mill. More particularly this invention concerns a water box for a rolling mill.

### BACKGROUND OF THE INVENTION

A typical apparatus for water-cooling the workpiece in a mill making wire or rod, hereinafter termed a wire mill, has a plurality of cooling units that are arranged in a row in the travel direction of the wire and that each comprise a pair of support shells that can interlock with one another and that hold guides for the wire and feed channels for the cooling medium, normally water.

An apparatus of this type as described in U.S. Pat. No. 5,257,511 comprises a series of semicircular bodies,.positioned sequentially and constituting generally semicylindrical half-shells that enclose a guide tube for the wire rod and feed channels for the cooling medium. These apparatuses are very complex in terms of construction, since the half-shells are held together by clamps positioned on the outside and each require a coupling to the water infeed lines. This construction makes it quite difficult to maintain and exchange components.

### OBJECTS OF THE INVENTION

It is therefore an object of the present invention to provide an improved rolling-mill water box.

Another object is the provision of such an improved rolling-mill water box that overcomes the above-given disadvantages, in particular that is of simple and compact construction and that can readily be serviced and/or refitted for workpieces of different size.

### SUMMARY OF THE INVENTION

A water box for a wire-rolling mill has according to the invention a lower support and a lower plate carried on the lower support, extending horizontally below a path of a wire moving in a horizontal travel direction, and formed with an upwardly open groove extending parallel to and open toward the path. An upper support above the lower support carries an upper plate formed with a straight seat groove. Respective upper and lower guide bars seated in the grooves of the upper and lower plates are formed with respective straight channels open away from the respective plates. A hinge connected between the supports permits movement of the upper plate between a closed position closely juxtaposed with the lower plate and with the channels confronting each other and forming a passage surrounding the path and an open position spaced upward away from the lower plate. In the closed position the wire is transversely enclosed by the channels. A coolant, typically water, is moved through the passage in the closed position.

Typically such water boxes are set up as modules in a row, three in a normal set. The hot wire from the last die or roller pair of the mill enters each module into which water is squirted and is cooled and even tempered as it moves downstream.

With this system only the upper support arms have to be pivoted, of which for each cooling unit two are provided spaced apart in the wire-travel direction. The upper plates carrying the bars are fitted complementarily to the respective grooves of the plates and axially fixed. Any errors in alignment can be compensated by the pistons of hydraulic actuators fitted with stainless cup springs. In contrast, the lower support arms with the built-in and axially fixed lower plates are rigidly fixed on the water boxes.

For pivoting/opening, the upper support arms are advantageously provided with a handwheel including a handwheel spindle. Alternatively, a lifting mechanism, e.g. a cylinder or an adjusting unit, can be provided for opening or closing the guide/passages.

In accordance with another suggestion of the invention, a cross-member or beam joins the upper plates or the upper support arms of all of the cooling units for the water boxes to one another. This way, all of the throughgoing passages can be opened and closed simultaneously using one adjusting motion.

These bars advantageously are of rectangular or square cross section and preferably have in all of their side faces longitudinal channels with different diameters from side face to side face, which makes it possible on the one hand to combine guide channels with different diameters using appropriate rotational positioning of the bars. On the other hand, each bar or cooling body insert part can be used four times using simple rotational positioning so that quadruple the service life can be attained. The wire is fed to these guide channels together with the cooling water through nozzle heads that project into the guide channel and that are positioned securely to the side of each plate.

### BRIEF DESCRIPTION OF THE DRAWING

The above and other objects, features, and advantages will become more readily apparent from the following description, reference being made to the accompanying drawing in which:

FIG. 1 is a cross section taken along line I-I of FIG. 2 through the apparatus according to the invention;

FIG. 2 is a longitudinal section through the apparatus; and

FIG. 3 is a view like FIG. 1 showing an alternative system in accordance with the invention.

### SPECIFIC DESCRIPTION

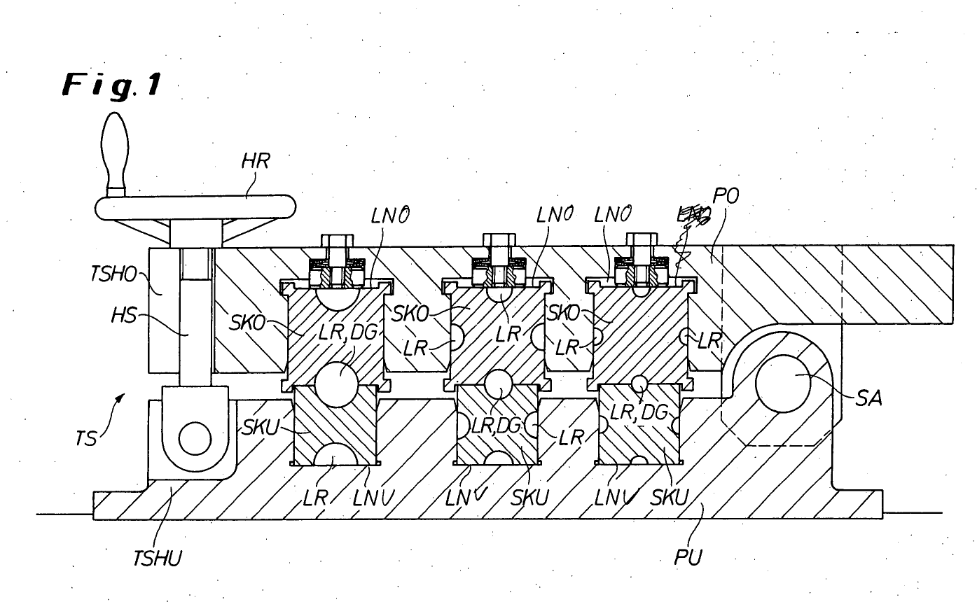

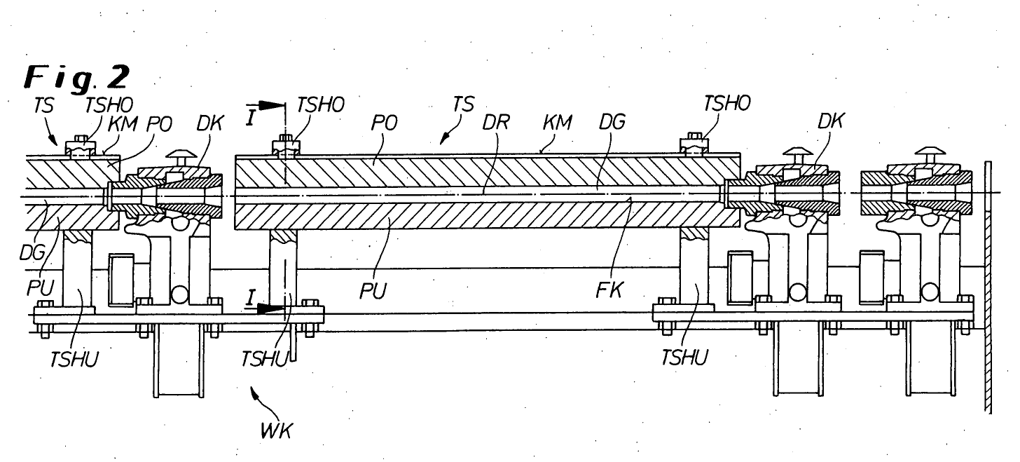

As seen in FIG. 1, a support assembly TS of a cooling unit KM of a water box WK (see FIG. 2) comprises upper and lower rectangular plates PO and PU that are horizontally one over the other, that are mounted on or even part of upper and lower support arms TSHO and TSHU shown in FIG. 2, that in turn are connected to one another at a horizontal pivot axis SA like a hinge. The plates PO and PU can be-pressed against one another by handwheel spindles HS of hand wheels HR. The pivot axis SA is situated opposite the service side of the cooling unit KM and is formed by the lower support arm TSHU that are rigidly fixed to the water box WK.

The upper plate PO, which is pivotable via the upper arms TSHO, is thus also clamped in place by the hand wheels HR, two per cooling unit KM, one at each upper support arm TSHO. These are positioned at the ends of the respective threaded handwheel spindles HS that are pivotally mounted in the lower plate PU or its lower support arms TSHU. The plates PO and PU have respective upper and lower longitudinal grooves LNO and LNU that are formed in their confronting lower and upper faces, that extend parallel to the pivot axis SA, and that open toward one another. Respective bars SKO or SKU is inserted in each of these longitudinal grooves LNO and LNU, and in the illustrated embodiment each have a largely square cross-sectional shape.

Each of the four side faces of each of these bars SKO and SKU has a longitudinal channel or flute LR, in this-case with a semicircular cross-section. The bars SKO inserted into the longitudinal grooves LN of the upper plate PO and the bars SKU inserted into the longitudinal grooves LN of the lower plate PU are positioned one above the other with longitudinal channels LR facing one another and thereby form throughgoing passages DG of circular cross-section when the two plates PO and PU have been pressed against each other. The bars SKO and SKU can also each be formed by a plurality of longitudinally concatenated parts.

As shown in FIG. 2, nozzle heads DK for the wire indicated schematically at DR that passes through are positioned upstream and downstream of the upstream and downstream ends of the passages DG. The nozzle head DK positioned on the right in the drawing upstream of the through channel DG has a nozzle tip that extends into the upstream passage end and with which the wire DR and the cooling water are introduced into the passages DG, while the nozzle head DK positioned behind the passage DG receives the emerging wire and some of the cooling water and feeds them to the subsequent downstream passage DG of the subsequent cooling unit KM of the water box WK.

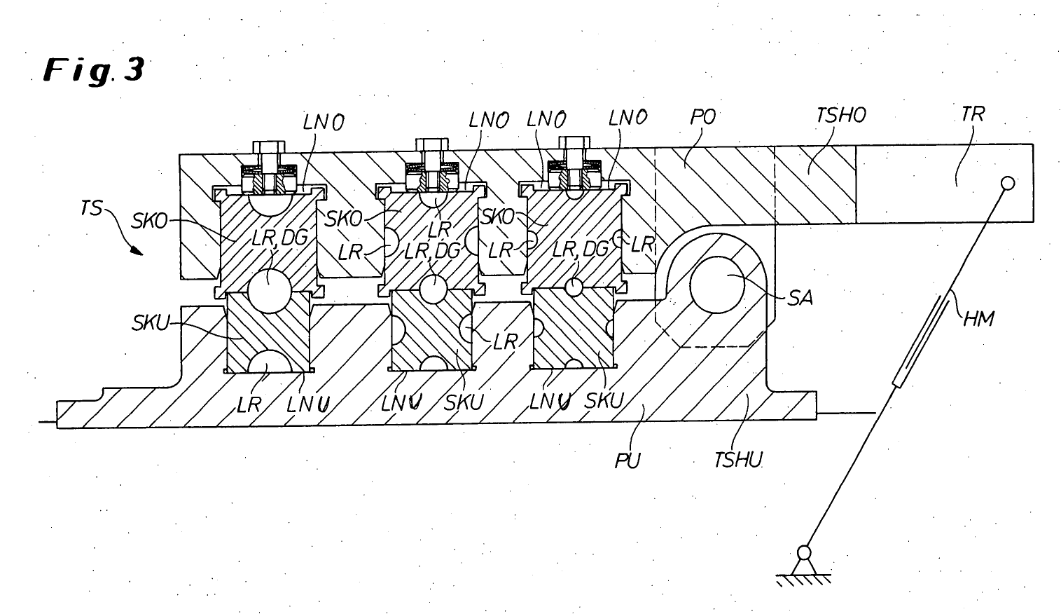

In FIG. 3, where the structure is,otherwise largely identical to that of FIG. 1, a pivotal lifting mechanism HM is provided that engages the supporting support arm TSHO of the upper plate PO for opening and for closing the upper plate PO of a cooling unit KM, instead of a hand spindle adjustment.

The apparatus makes possible easy accessibility at all times by simply opening the upper plate PO and thus facilitates the rapid and simple removal of waste if there is a problem and facilitates inspection and maintenance.

In particular when a lifting mechanism HM is used it is simple to simultaneously open the upper plate PO for all successive cooling units KM of the water box WK or to secure them to the lower plates PO. For this it is merely necessary for the upper support arms TSHO of all of the cooling units KM to be connected to a common connecting member or beam TR that is acted upon by the lifting mechanism HM, as is indicated schematically for one cooling unit in FIG. 3.

We claim:

1. A water box for a wire-rolling mill, the water box comprising:
a lower support;
a lower plate carried on the lower support, extending horizontally below a path of a wire moving in a horizontal travel direction, and formed with an upwardly open groove extending parallel to and open toward the path;
an upper support above the lower support;
an upper plate carried on the upper support and formed with a straight groove;
respective upper and lower guide bars seated in the grooves of the upper and lower plates and formed with respective straight channels open away from the respective plates;
means including a hinge connected between the supports for moving the upper plate between a closed position closely juxtaposed with the lower plate and with the channels confronting each other and forming a passage surrounding the path and an open position spaced upward away from the lower plate, whereby in the closed position the wire is transversely enclosed by the channels; and
means for flowing a coolant through the passage in the closed position.

2. The rolling-mill water box defined in claim 1 wherein the bars are of polygonal section and each have a plurality of faces, at least two of the faces each being formed with a respective one of the channels.

3. The rolling-mill water box defined in claim 2 wherein the channels of each bar are of different sizes, whereby the bars can be turned in the respective grooves to accommodate wires of different size.

4. The rolling-mill water box defined in claim 2, further comprising
means for releasably retaining the bars in the respective grooves.

5. The rolling-mill water box defined in claim 1 wherein the means for flowing a coolant through the passage includes a nozzle for squirting water into an end of the passage in the closed position.

6. The rolling-mill water box defined in claim 1 wherein each upper support is a pair of upper support arms fixed to the upper plate and spaced apart in the direction and each lower support is a pair of lower support arms fixed to the lower plate and spaced apart in the direction.

7. The rolling-mill water box defined in claim 6, further comprising
a beam extending in the direction and fixed-to and rigidly interconnecting the upper support arms.

8. The rolling-mill water box defined in claim 1, further comprising
means for pressing the upper plate and upper bar down on the lower plate and lower bar in the closed position.

9. The rolling-mill water box defined in claim 8 wherein the closing means includes a threaded spindle attached to one of the upper and lower supports and a threaded hand wheel fitted to the spindle and engageable with the other of the upper and lower supports.

10. The rolling-mill water box defined in claim 8 wherein each upper support is a pair of upper support arms fixed to the upper plate and spaced apart in the direction and each lower support is a pair of lower support arms fixed to the lower plate and spaced apart in the direction, one such spindle being provided on each of the lower arms with a respective such hand wheel engageable with the respective upper arm.

11. The rolling-mill water box defined in claim 1, further comprising
a lifter engaged between the upper and lower supports
